(19) United States
(12) Patent Application Publication
(10) Pub. No.: US 2021/0338008 A1
(43) Pub. Date: Nov. 4, 2021

(54) SERVER DEVICE, METHOD FOR SERVER DEVICE, AND ELECTRONIC DEVICE

(71) Applicant: Cookpad Inc., Tokyo (JP)

(72) Inventors: Shinya OHTANI, Tokyo (JP); Masayuki IOKI, Tokyo (JP); Akihisa KANEKO, Tokyo (JP); Tomomichi SUMI, Tokyo (JP); Jun HARASHIMA, Tokyo (JP)

(73) Assignee: Cookpad Inc., Tokyo (JP)

(21) Appl. No.: 17/352,368

(22) Filed: Jun. 21, 2021

Related U.S. Application Data
(63) Continuation of application No. PCT/JP2018/047659, filed on Dec. 25, 2018.

(51) Int. Cl. A47J 36/32; A23L 5/00; A47J 27/00; G05B 15/02

(52) U.S. Cl. CPC A47J 36/321; G05B 15/02; A47J 27/004; A23L 5/00

(57) ABSTRACT

A server device, characterized by comprising: comprising: a memory and at least one processor configured to:
detect a second cooking process performed by a user who is cooking according to a cooking recipe involving a first cooking process; and
in a case where a predetermined condition that the second cooking process detected by the detection unit deviates from the first cooking process is met, performs control for outputting a modified cooking recipe resulting from subjecting the first cooking process to at least one of reordering relevant steps, adding a step, or removing a step based on a configuration of the first cooking process and a configuration of the second cooking process that meets the predetermined condition.

### CROSS-REFERENCE TO RELATED APPLICATION

This application is a continuation of and claims priority to International Patent Application No. PCT/JP2018/047659, filed on Dec. 25, 2018, which is incorporated by reference herein in its entirety.

### TECHNICAL FIELD

The present disclosure relates to a server device, an information processing terminal, a system, a method, and a program that enable flexibly and appropriately addressing various cooking errors and proposing a recipe suitable for the situation.

### BACKGROUND

A variety of recipes have recently been provided through the Internet, television, and magazines. Such recipes, describing a sequence of cooking steps, can be used by users in general. For example, a conventional method in which a host device storing pieces of cooking recipe data provides, over a communication network, cooking recipe data resulting from a search requested by a user.

A user who has obtained a recipe in the above manner typically does cooking according to the recipe and finally completes a dish. During the cooking, however, the user may change a setting of a cooking appliance, such as the heating temperature or the heating time. Conventional systems may detect a change, such as a setting change on a cooking appliance, and, if making the change results in a sequence of cooking steps with the same ingredients, incorporating the change into the recipe.

### SUMMARY

The present disclosure provides a server device that includes a memory that stores recipe information indicating a first cooking process. The server device further includes processing circuitry configured to detect a second cooking process performed by a user who is cooking according to the recipe information; determine whether the second cooking process deviates from the first cooking process indicated in the recipe information; and in a case that the second cooking process is determined to deviate from the first cooking process: generate a modified cooking process by adjusting the first cooking process based on detected cooking steps taken by the user during performance of the second cooking process; and control output of modified recipe information indicating the modified cooking process.

### BRIEF DESCRIPTION OF THE DRAWINGS

FIG. 1 is a diagram illustrating a data structure of recipe information in accordance with the present disclosure.

FIG. 2 is a configuration diagram of a recipe control system 1 in accordance with the present disclosure.

FIG. 3 is a block diagram illustrating an exemplary hardware configuration of components of recipe control system 1.

FIG. 4 is a diagram illustrating the functional block configuration of a terminal device 200 in accordance with the present disclosure.

FIG. 5 is a diagram illustrating an exemplary configuration of history information in accordance with the present disclosure.

FIG. 6 is a diagram illustrating the functional block configuration of a recipe control server 300 in accordance with the present disclosure.

FIG. 7 is a diagram illustrating an exemplary configuration of a recipe information DB in accordance with the present disclosure.

FIG. 8 is a diagram illustrating an exemplary configuration of a recipe execution history DB in accordance with the present disclosure.

FIG. 9 is a diagram illustrating an exemplary configuration of a recipe integration rule DB in accordance with the present disclosure.

FIG. 10 is a diagram illustrating the functional block configuration of an appliance 100 in accordance with the present disclosure.

FIG. 11 is a diagram illustrating first exemplary operations of the recipe control system 1 in accordance with the present disclosure.

FIG. 12 is a diagram illustrating second exemplary operations of the recipe control system 1 in accordance with the present disclosure.

### DETAILED DESCRIPTION OF THE DRAWINGS

Conventionally, adjusting a recipe to a change made during cooking, such as a setting change on an appliance, has been performed. In practice, various situations require recipe modification during cooking, and methods based on conventional techniques may often fail to address such different situations. For example, an incorrectly performed step or the use or preparation of a wrong ingredient may be found in an advanced stage of cooking while totally unexpected by the user. Such an error will not be recovered by simply changing a setting of a cooking appliance.

As another example, although the user thinks that all the necessary ingredients are ready, a lack or shortage of a key ingredient may be found during cooking. Then, the desired dish according to the recipe cannot probably be expected. The user in such a situation may feel like abandoning the cooking or taking a risk to redirect the cooking to some other dish. In any case, the user's motivation for cooking decreases.

The above problem is likely to be further worsened when multiple recipes are used in parallel. For example, an ingredient shortage or an incorrectly performed step found for a certain recipe inevitably affects cooking with another recipe that is used in parallel and that utilizes the dish made according to the certain recipe. If the user tries to settle the situation, operational steps across the recipes assumed at the beginning of the cooking can become complicated and further increase the confusion. The inventors of the present disclosure have developed technology to address these issues.

In particular, the inventors of the present disclosure have developed technology to provide a server device, an information processing terminal, a system, a method, and a program that enable flexibly and appropriately addressing various cooking errors and proposing a recipe suitable for the situation. In accordance with the present disclosure, a server device includes: a detection unit that detects a process error with respect to a user performing cooking according to a recipe; and a recipe modification unit that, if the process error is detected, checks an erroneous step involved in the process error against a sequence of steps indicated by the recipe, subjects the recipe to a recovery measure including at least one of reordering of steps relevant to the erroneous step, adding a step, or removing a step, and outputs the recipe subjected to the recovery measure.

An information processing terminal according to the present disclosure includes: an information obtainment unit that obtains the recipe subjected to the recovery measure from the server device; and an output unit that outputs information about the recipe.

A system according to the present disclosure includes a server device including: a detection unit that detects a process error with respect to a user performing cooking according to a recipe; and a recipe modification unit that, if the process error is detected, checks an erroneous step involved in the process error against a sequence of steps indicated by the recipe, subjects the recipe to a recovery measure including at least one of reordering of steps relevant to the erroneous step, adding a step, or removing a step, and outputs the recipe subjected to the recovery measure. The system also includes an information processing terminal including: an information obtainment unit that obtains the recipe subjected to the recovery measure from the server device; and an output unit that outputs information about the recipe.

A method according to the present disclosure includes the steps of: detecting a process error with respect to a user performing cooking according to a recipe; and, if the process error is detected, checking an erroneous step involved in the process error against a sequence of steps indicated by the recipe, subjecting the recipe to a recovery measure including at least one of reordering of steps relevant to the erroneous step, adding a step, or removing a step, and outputting the recipe subjected to the recovery measure. The present disclosure enables flexibly and appropriately addressing various cooking errors and proposing a recipe suitable for the situation.

Embodiments of the present disclosure will be described below with reference to the drawings. Throughout the drawings , like elements are given like symbols and will not be described repeatedly. The embodiments below are not intended to unnecessarily limit the scope of the present disclosure set forth in the claims. Not all of the elements illustrated in the embodiments are essential for the present disclosure.

<Overview>

A recipe control system according to the present disclosure enables flexibly and appropriately addressing various cooking errors and proposing a recipe suitable for the situation.

Information about recipes (hereafter referred to as recipe information) in the present disclosure may include both recipe information that quantitatively describes cooking details and recipe information that qualitatively describes cooking details.

Recipe information, whichever type it is, needs to include steps to be sequentially performed and needs to clearly describe the details of each step. Qualitatively expressed recipe information still needs to appropriately include quantitative expressions necessary for modifying the recipe, such as reordering, adding, or removing steps.

Such quantitative expressions are used to describe operations of a cooking process with specific numerical values. More specifically, quantitative expressions are used in descriptions such as “bake the meat for 20 minutes in the oven preheated to 200 degrees Celsius,” “3 grams of salt,” and “microwave the potatoes for 5 minutes at 600 W.” Quantitative expressions use specific numerical values to convey the details of operations performed with cooking appliances (tools), and are therefore suitable for controlling cooking appliances.

A variety of recipes have recently been provided through the Internet, television, and magazines. Such recipes, describing a sequence of cooking steps, can be used by users in general.

A user who has obtained a recipe in the above manner typically does cooking according to the recipe and finally completes a dish. During the cooking, however, the user may often change a setting of a cooking appliance, such as the heating temperature or the heating time, for the user's convenience or due to the conditions of ingredients, resulting in recipe modification.

In practice, various situations require such recipe modification. In some cases, unlike the above case of the user-intended setting change, an incorrectly performed step or the use or preparation of a wrong ingredient may be found in an advanced stage of cooking while totally unexpected by the user, resulting in unintended recipe modification. Such an error will not be recovered by simply changing a setting of a cooking appliance.

In other cases, although the user thinks that all the necessary ingredients are ready, a lack or shortage of a key ingredient may be found during cooking.

Then, the desired dish according to the recipe cannot probably be expected. The user in such a situation may feel like abandoning the cooking or taking a risk to redirect the cooking to some other dish. In any case, the user's motivation for cooking decreases.

The above problem is likely to be further worsened when multiple recipes are used in parallel. For example, an ingredient shortage or an incorrectly performed step found for a certain recipe inevitably affects cooking with another recipe that is used in parallel and that utilizes the dish made according to the certain recipe. If the user tries to settle the situation, operational steps across the recipes assumed at the beginning of the cooking can become complicated and further increase the confusion.

The recipe control system according to the present disclosure enables flexibly and appropriately addressing various cooking errors and proposing a recipe suitable for the situation.

<Recipe Information>

Exemplary recipe information contemplated according to the present disclosure is recipe information including a sequence of cooking steps and interpretable by a cooking appliance, that is, quantitatively described recipe information. Although the recipe information may serve as control information for controlling cooking operations of a cooking appliance, such control is not essential for the present disclosure. Nevertheless, the quantitatively described recipe information is more preferably used as control information for a cooking appliance (an appliance 100), in addition to being presented to a user. This will enable automatically making a dish desirable for the user while appropriately addressing the user's situation.

If recipe information is used to control a device such as a cooking appliance, the device to be controlled is a device associated with ingredients of a dish or with cooking performed using the ingredients (including a device that simply outputs information). Given the recipe information, a cooking appliance performs actions (processing) according to the recipe information. Recipe information readable and interpretable by a cooking appliance will herein be referred to as a machine-readable recipe (MRR).

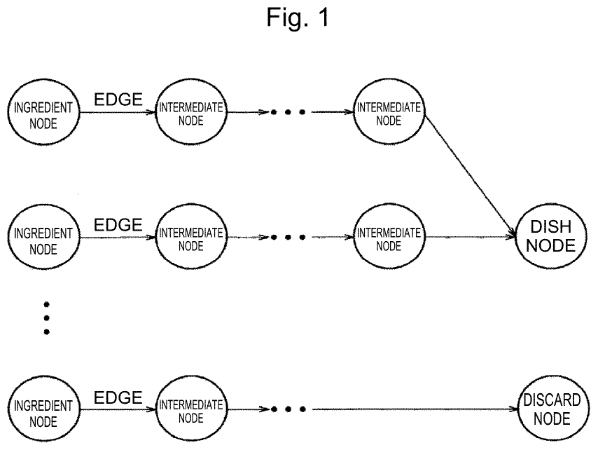

FIG. 1 is a diagram illustrating a data structure of recipe information according to the present disclosure. As shown in FIG. 1, the recipe information, which is an MRR, according to the present disclosure is represented as a graph (directed graph) that includes nodes and edges between the nodes. In FIG. 1, circles represent nodes, and arrows represent edges.

The nodes define the transitional states of ingredients. Each edge represents an action necessary for state transition between nodes. An action refers to a basic step of cooking, for example a step such as “cut” or “heat.” An action may include a specific set temperature and cooking time of an appliance, and the details of an operation. Action types and their IDs may be predetermined, or action types may be given their IDs later. A list of actions and their IDs is defined, and each edge is assigned an action ID selected from the list. Each state (intermediate node) may also be assigned an ID.

The nodes in the graph include: ingredient nodes that serve as start points of the graph and represent the ingredients of a dish to be made; a dish node that serves as the end point of the graph and represents the dish; and intermediate nodes that represent the states of the ingredients in the process leading to the dish.

The ingredients refer to food materials for making the dish and may include seasonings and discarded materials to be discarded during the cooking. Ingredient types and their IDs are predetermined. A list of ingredients and their IDs is defined, and each ingredient node is assigned an ingredient ID selected from the list.

The state of an ingredient refers to the state of the ingredient subjected to an action. For example, the state of an ingredient may be “an ingredient A cut into three equal pieces,” “an ingredient B cut into 3-cm dices,” or “an ingredient C heated.”

As above, the data structure of the recipe information according to the present disclosure represents the state transitions of the ingredients as a graph, rather than representing recipe sentences written in a natural language directly as a graph.

Each ingredient is assigned an ingredient ID that uniquely identifies the ingredient. Each action required for state transition is assigned an action ID that uniquely identifies the action. This allows ready and reliable machine interpretation of the recipe information based on the IDs.

Because the recipe information does not necessarily have to specify an appliance that is to perform each action, the recipe information can readily support various appliances, including appliances that will emerge in the future. Further, because all actions are represented as edges, actions can be readily extracted from the recipe information.

A partial graph is obtained by removing some edges and further removing some isolated nodes from the graph as shown in FIG. 1. Such a partial graph can be regarded as recipe information indicating a cooking subprocess performed by controlling a particular cooking appliance in the sequential cooking process indicated by the entire recipe information.

Table 1 illustrates exemplary node types in recipe information:

TABLE 1

| Node type | Description |
|---|---|
| Ingredient | A node representing an ingredient of a dish and serving |
| node | as a start point of a graph. The node requires an |
| | ingredient ID. |
| Intermediate | A node having IN and OUT edges and representing an |
| node | intermediate state of a dish. |
| Discard node | A node representing an object such as skin peeled off The |
| | node is a terminal node but does not represent a dish. |
| Dish node | A terminal node representing a dish. |
| Special node | A supplementary node for an appliance, representing |
| | details such as preheating an oven. |

Each node can be assigned node attributes, for example those shown in Table 2. The example here assumes that the node is an ingredient node representing “carrot”:

TABLE 2

| Node attribute | Example |
|---|---|
| State | Raw |
| Name | Carrot (or Ingredient ID) |
| Amount | The amount (weight) of the ingredient |

“Name” is information needed by a human to create or interpret an MRR and does not necessarily have to be machine-readable.

Each edge can be assigned edge attributes such as those shown in Table 3:

TABLE 3

| Edge attribute | Description |
|---|---|
| Name | An action name such as “cut” or “heat.” |
| Action ID | An ID corresponding to the action name. |
| Termination | The condition for terminating the action, such as |
| condition | cutting into “3-cm dices” or simmering for “5 |
| | minutes.” |
| Appliance ID | An ID representing an appliance such as “oven” or |
| | “microwave oven.” |
| Position in the | A number representing the position in the order of |
| edge order | performing actions. |

The following description takes specific examples of nodes. In making a dish “salad,” the dish node is “salad.” The ingredient nodes are, for example, “onion,” “cucumber,” “tomato,” “ketchup,” and “mayonnaise.” Each ingredient node is assigned an ID that uniquely identifies the ingredient.

The ingredient node “onion” is connected by an edge (action) “cut” to an intermediate node “chopped onion.” The ingredient node “cucumber” is connected by an edge (action) “cut” to an intermediate node “1-cm diced cucumber”.

Further, the ingredient node “tomato” is connected by an edge (action) “cut” to an intermediate node “halved tomato”. Still further, the ingredient nodes “ketchup” and “mayonnaise” are each connected by an edge (action) “mix” to an intermediate node “aurora sauce.” Each of the actions “cut” and “mix” is assigned an ID that uniquely identifies the action.

The intermediate nodes “chopped onion,” “1-cm diced cucumber,” and “halved tomato” are each connected by an edge (action) “arrange on a plate” to the dish node “salad.” The intermediate node “aurora sauce” is connected by an edge (action) “put on” to the dish node “salad.” Each of the actions “arrange on a plate” and “put on” are assigned an ID that uniquely identifies the action. The edges are ordered so that “put on” comes after “arrange on a plate.” The action “put on” may be replaced with an action “mix with.”

The configuration of the recipe control system that uses the above-described data structure will now be described.

(Configuration of Recipe Control System 1)

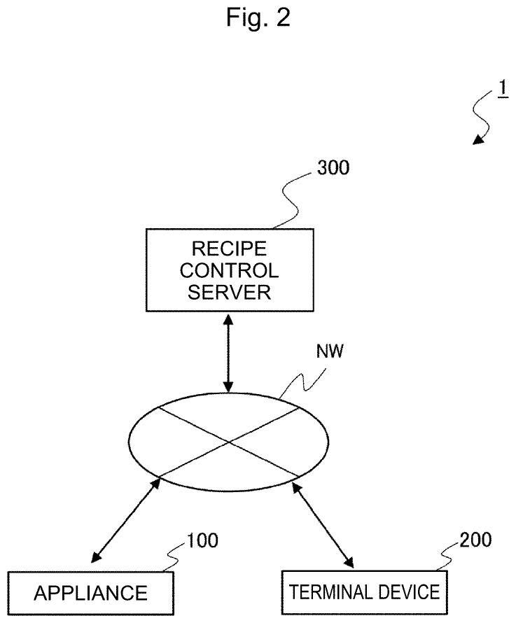

FIG. 2 illustrates is a configuration diagram of a recipe control system 1.

The recipe control system 1 includes an appliance 100, a terminal device 200, and a recipe control server 300, which are communicatively interconnected over a network NW. The network NW may include a Wide Area Network (WAN) and a local area network (LAN). The appliance 100 may bypass the network NW and directly communicate with the terminal device 200 (e.g., through short-range wireless communication). Although one appliance 100 and one terminal device 200 are representatively shown in FIG. 2, multiple appliances 100 and multiple terminal devices 200 may be connected to the network NW.

The appliance 100, having a communication function, is located in a kitchen and associated with ingredients of a dish or with cooking performed using the ingredients. The appliance 100 may be a consumer electronic appliance used at home, or an appliance for professional use.

The appliance 100 may be any appliance located in a kitchen and associated with ingredients or with cooking performed using the ingredients. For example, the appliance 100 may be a refrigerator, a microwave oven, an oven, an induction cooker, a toaster oven, a food processor, a mixer, a rice cooker, an electric pot, an electric fryer, an electric steamer, a noodle maker, a kitchen scale, a cooking robot, a gas cooker, or lighting equipment.

The appliance 100 receives recipe information as described above from the recipe control server 300 and accordingly outputs the recipe information for presentation to the user.

The terminal device 200, having a communication function, provides a user interface. In response to the user's operation, the terminal device 200 posts (sends) recipe information (such as recipe text and dish image data) to the recipe control server 300. The terminal device 200 also receives recipe information as described above from the recipe control server 300 and accordingly outputs the recipe information for presentation to the user.

The terminal device 200 is an information processing terminal, for example a mobile terminal (e.g., a tablet computer, a smartphone, a laptop computer, a feature phone, a portable gaming device, or an electronic book reader). The terminal device 200 may also be a television receiver (including an Internet television), a personal computer (PC), a virtual reality (VR) terminal, or an augmented reality (AR) terminal.

The recipe control server 300 stores recipe information posted by the terminal device 200. If a process error occurs with respect to the user who is using the recipe information, the recipe control server 300 takes an appropriate recovery measure based on information about an erroneous step or an ingredient shortage involved in the process error. The recovery measure may include reordering, adding, or removing steps in the original recipe information.

The recipe control server 300 transmits the recipe information subjected to the recovery measure to the terminal device 200 and/or the appliance 100. This recipe information is preferably machine-readable, having the above-described recipe data structure (see FIG. 1 and Tables 1 to 3). The recipe control server 300 transmits the recipe information to the terminal device 200 and/or the appliance 100 over the network NW.

The recipe control server 300 collects information from the appliance 100 or the terminal device 200. The information collected may include recipe information being used by the appliance 100 or by the user of the terminal device 200, details of cooking operations at the appliance 100 or the terminal device 200 at predetermined time intervals (e.g., which step is or has been taking place), and ingredients and their amounts being cooked or held by the appliance 100.

Based on the information collected, the recipe control server 300 checks for differences between the process indicated by the recipe information being used and cooking operations (including the sufficiency of ingredients) at the appliance 100 or the terminal device 200. The recipe control server 300 thus detects the user's process error (including an ingredient shortage).

If a process error is detected, the recipe control server 300 checks the erroneous step involved in the process error against the sequence of steps indicated by the recipe information. The recipe control server 300 then subjects the recipe information to a recovery measure that includes at least one of reordering steps relevant to the erroneous step, adding a step, or removing a step. The recipe control server 300 outputs the modified recipe information to the appliance 100 and/or the terminal device 200.

It may be found that taking the above recovery measure may not lead to the completion of the dish to be made according to the recipe information. This is the case such as when the process error (including the use of a wrong ingredient) is above a certain extent or when the erroneous process has proceeded to almost a final stage. The recipe control server 300 then identifies, from a predetermined recipe list, recipe information that can utilize the cooking up to the erroneous step, that is, recipe information that involves the same or substantially similar steps or ingredients. The recipe control server 300 outputs the recipe information identified to the appliance 100 and/or the terminal device 200.

The user who is experiencing the process error may do or may be doing cooking according to other recipe information, in addition to the recipe information involving the process error. That is, the user may be cooking according to multiple pieces of recipe information. The recipe control server 300 can also appropriately address such a situation.

To this end, the recipe control server 300 extracts, based on the attributes of the steps of each piece of recipe information, which constitutes the multiple pieces of recipe information, steps having attributes designated by a predetermined recipe integration rule. The steps are extracted from across the multiple pieces of recipe information, and are output to the appliance 100 and/or the terminal device 200 according to the recipe integration rule.

As an exemplary specific situation, the user who is cooking with recipe information A and recipe information B may experience a process error for the recipe information A as described above. One step in the recipe information A is a potential preparatory operation (e.g., preparation of an ingredient to be used) for a certain step in the recipe information B. The process error for the recipe information A may therefore affect the cooking with the recipe information B.

The recipe control server 300 extracts, from the recipe information A and B, attributes of the steps performed correctly before the occurrence of the process error in the recipe information A, and attributes of the steps unfinished in the recipe information B. The recipe control server 300 identifies cooking details in a mutual user-used relationship between the two pieces of recipe information. This user-used relationship may be the relationship between one step and its potential preparatory step, as described above, or the relationship in which a resultant product or a remaining ingredient in one step will be used as an ingredient in another step.

The recipe control server 300 orders the steps of the pieces of recipe information extracted as above in an order consistent with the above user-used relationship identified across the pieces of recipe information, and outputs the sequence of steps to the appliance 100 and/or the terminal device 200.

The appliance 100 and/or the terminal device 200 receives the recipe information subjected to the above recovery measure and displays the recipe information on an output device. If the recipe information is an MRR, the appliance 100 may start cooking operations according to the MRR.

If the recipe information is simply output on the terminal device 200 and/or the appliance 100 and is not used as the MRR for automatic cooking operations in the appliance 100, the above MRR-based actions in the appliance 100 may be omitted.

(Hardware Configuration)

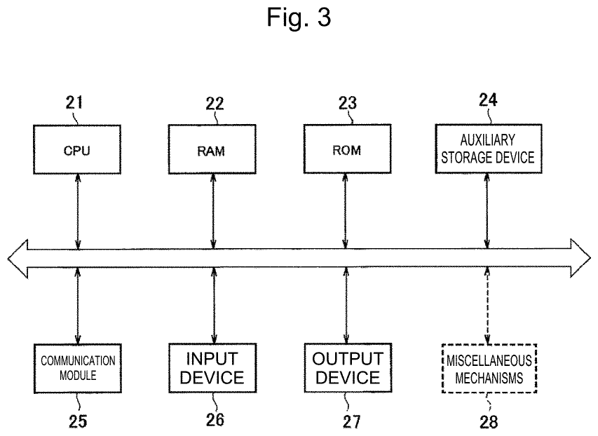

The hardware configuration of the appliances and devices in the recipe control system 1 will be described. FIG. 3 illustrates a block diagram of an exemplary hardware configuration of components of recipe control system 1. In an exemplary implementation, the appliance 100, the terminal device 200, and the recipe control server 300 includes the hardware components illustrated in FIG. 3.

In an exemplary implementation, the appliance 100, the terminal device 200, and the recipe control server 300 are implemented using circuitry or processing circuitry which includes general purpose processors, special purpose processors, integrated circuits, ASICs (“Application Specific Integrated Circuits”), CPU (a Central Processing Unit), a micro processing unit (MPU), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

As shown in FIG. 3, each of the appliance 100, the terminal device 200, and the recipe control server 300 includes a CPU 21, a RAM 22, a ROM 23, an auxiliary storage device 24, a communication module 25, an input device 26, and an output device 27.

The CPU 21 reads software (programs) from the RAM 22 and the ROM 23, which form main storage, and executes the software.

The RAM 22 is used as a working area for the CPU 21. The auxiliary storage device 24 may include a hard disk or a flash memory.

The communication module 25 sends and receives data through wired or wireless communication. The input device 26 may include a touch panel and/or a keyboard, and receives user operations. The input device 26 may also receive operations through voice input. The output device 27 may include a display, and outputs (displays) various sorts of information.

Software is read into hardware such as the CPU 21 and the RAM 22 to cause the communication module 25, the input device 26, and the output device 27 to operate, and cause the RAM 22 and the auxiliary storage device 24 to read and write data, under the control of the CPU 21. This achieves a series of functions in each of the appliances and devices.

The appliance 100 further includes miscellaneous mechanisms 28. The miscellaneous mechanisms 28 include mechanisms for performing actions in the appliance 100, for example a heating mechanism, a refrigerating and freezing mechanism, a cutting mechanism, and a mixing mechanism.

(Functional Block Configuration of Terminal Device 200)

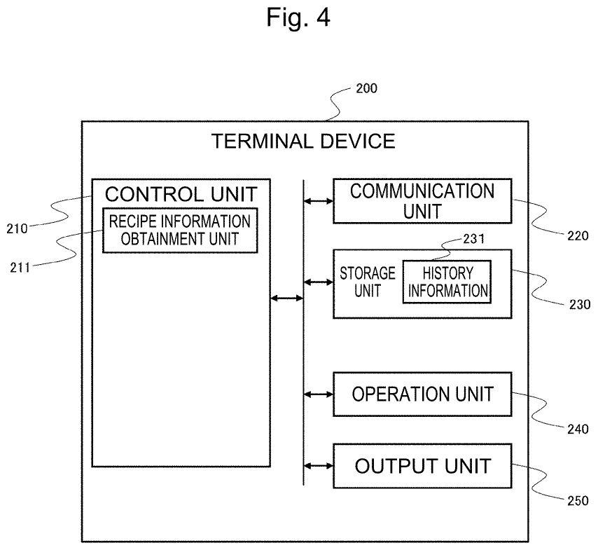

The functional block configuration of the terminal device 200 will be described. FIG. 4 is a diagram illustrating the functional block configuration of the terminal device 200 according to the present disclosure.

As shown in FIG. 4, the terminal device 200 includes a control unit 210, a communication unit 220, a storage unit 230, an operation unit 240, and an output unit 250.

The control unit 210 is implemented by the processing circuitry discussed above with respect to FIG. 3. For example, the control unit 210 includes the CPU 21 and controls the operations of the terminal device 200. The communication unit 220 includes the communication module 25 and performs communication over the network NW. The communication unit 220 may have a function of directly communicating with the appliance 100. The storage unit 230 includes the RAM 22, the ROM 23, and the auxiliary storage device 24, and stores various sorts of information and data.

The above control unit 210 includes a recipe information obtainment unit 211. The recipe information obtainment unit 211 obtains, in response to the user's operation on the operation unit 240, recipe information from the recipe control server 300 through the communication unit 220. Specifically, the recipe information obtainment unit 211 obtains a quantitative HRR that includes quantitative expressions and is human-interpretable, or an MRR that is recipe information readable and interpretable by the appliance 100. This MRR may be the base of the recipe information. The recipe information obtained from the recipe control server 300 in this manner may include recipe information modified through the above-described recovery measure.

The recipe information obtainment unit 211 may obtain recipe information selected by the user from a recipe list displayed on the output unit 250, or may search the recipe control server 300 to obtain recipe information that meets a search condition (such as a keyword). The recipe information obtainment unit 211 causes the output unit 250 to display the recipe information obtained.

The storage unit 230 maintains history information 231, which is a history of cooking operations performed by the user of the terminal device 200 according to recipe information.

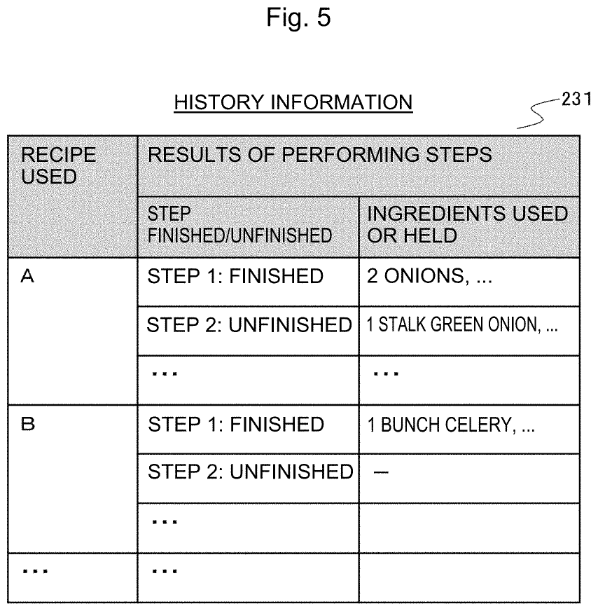

For example, the history information 231 indicates each recipe used and its associated results of performing the steps, as shown in FIG. 5. The results of performing the steps shown illustrate the values of the steps finished/unfinished, and the values of the amounts of ingredients used or held. The steps finished/unfinished literally show whether each step has been finished or not. The ingredients used or held show ingredients used or held in each step. An “ingredient held” is a resultant product obtained by performing a step. An ingredient held in the final step of the recipe information is the dish to be made according to the recipe information. An ingredient held in each step before the final step may be required in a later step.

Resources for the history information 231 may be, but not limited to, resources obtained by the terminal device 200 communicating with the appliance 100, or resources received from the user through the operation unit 240, for example.

The operation unit 240 includes the input device 26 and receives the user's operations. The output unit 250 includes the output device 27 such as a display and a speaker, and displays or audibly outputs various sorts of information and data.

(Functional Block Configuration of Recipe Control Server 300)

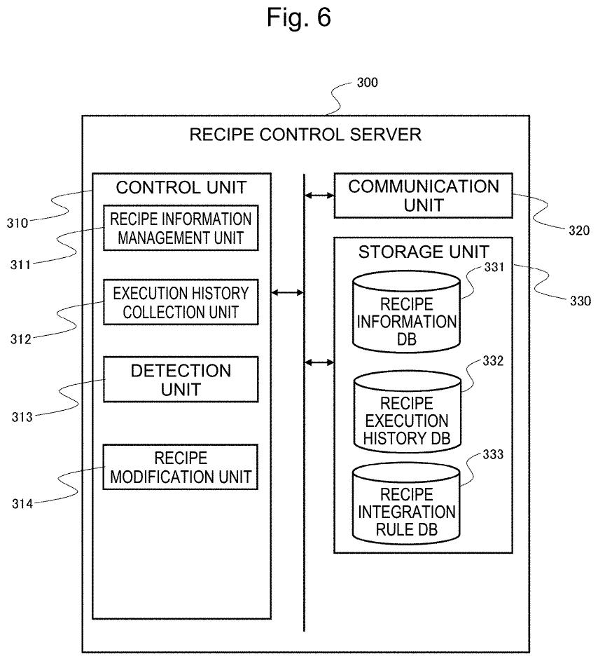

The functional block configuration of the recipe control server 300 will be described. FIG. 6 is a diagram illustrating the functional block configuration of the recipe control server 300 according to the present disclosure.

As shown in FIG. 6, the recipe control server 300 includes a control unit 310, a communication unit 320, and a storage unit 330.

The control unit 310 is implemented by the processing circuitry discussed above with respect to FIG. 3. For example, the control unit 310 includes the CPU 21 and controls the operations of the recipe control server 300. The communication unit 320 includes the communication module 25 and performs communication over the network NW.

The storage unit 330 includes the RAM 22, the ROM 23, and the auxiliary storage device 24, and stores various sorts of information and data. The storage unit 330 includes a recipe information DB 331, a recipe execution history DB 332, and a recipe integration rule DB 333. These DBs will be described below in connection with the components of the control unit 310.

The control unit 310 includes a recipe information management unit 311, an execution history collection unit 312, a detection unit 313, and a recipe modification unit 314.

The recipe information management unit 311 obtains, through the communication unit 320, recipe information posted by users and stores the recipe information in the recipe information DB 331.

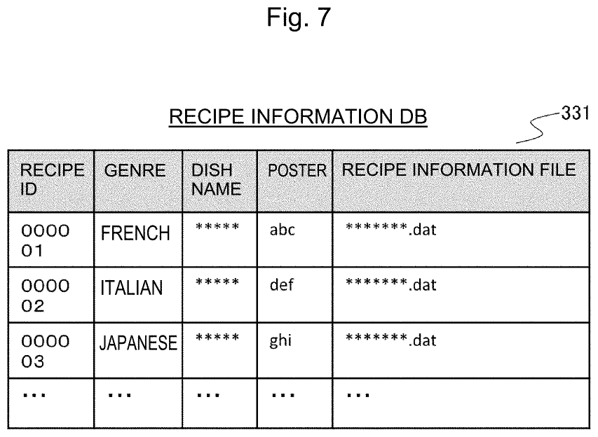

The recipe information DB 331 stores multiple pieces of recipe information as illustrated in FIG. 7. For example, the recipe information DB 331 stores recipe information posted by users, and recipe information generated in advance by the operator of the recipe control system 1. Each piece of recipe information may include ratings and comments provided by users who used the piece of recipe information.

The recipe information DB 331 may include recipe information in MRR form, as well as recipe information described with sets of qualitative expressions and accompanying quantitative expressions. For example, as in “fry garlic until aromatic with an IH cooker at 600 W for 3 minutes,” recipe information may be described with a set of a qualitative expression “aromatic” and accompanying quantitative expressions “600 W” and “3 minutes.” As another example, a cooking step described with a qualitative expression may have a comment provided by a user who actually made the dish, suggesting a specific setting of a cooking appliance, or may have a quantitative expression added by the operator of the recipe control system 1.

The recipe information management unit 311 also has a function of responding to a search request from the terminal device 200 or the appliance 100 to generate, from the recipe information DB, a list of recipes that meet a search condition, and transmit the recipe list to the terminal device 200 or the appliance 100.

The execution history collection unit 312 collects, through the communication unit 320, information about the state of the appliance 100 operating according to the recipe information (MRR) as described above, or information reported by the user of the terminal device 200. The execution history collection unit 312 stores the collected information in the recipe execution history DB 332.

The information collected from the appliance 100 or the terminal device 200 may be information about the recipe information being used by the user, including each step finished/unfinished and the weight or amount of each ingredient used or held.

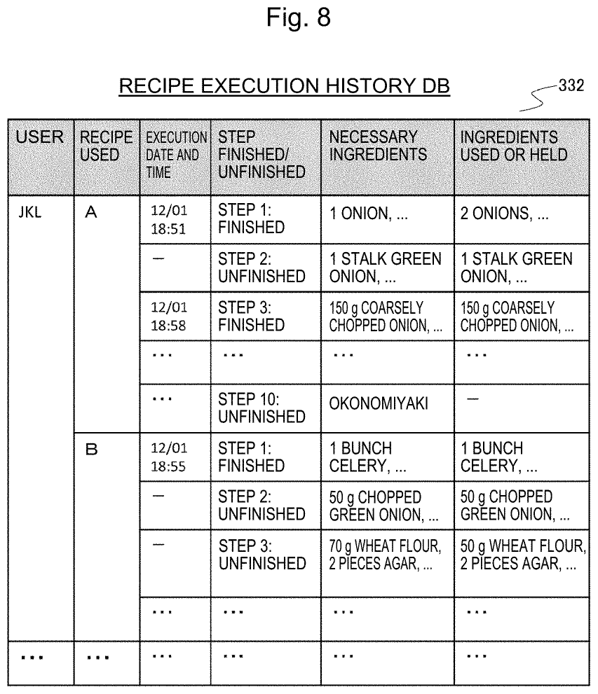

FIG. 8 illustrates an example of the recipe execution history DB 332. The recipe execution history DB 332 stores predetermined information about recipe information, and the above-described information about the recipe information obtained from the appliance 100 or the terminal device 200 (such as history information 131 or the history information 231).

This data structure includes records that indicate the values of: identification information on each recipe user; the names of recipes used by each user; the execution date and time of each step; steps finished/unfinished in each recipe used; necessary ingredients specified for each step by the recipe information; and ingredients used or held.

The value of each step finished/unfinished is the value, obtained from the appliance 100, of the state of performing the cooking step according to the MRR, or a value input by the user on the terminal device 200. The value of each ingredient used or held is the value, obtained from the appliance 100, of the weight or amount of the ingredient sensed by a sensor or reader provided in the appliance 100. The value of each ingredient used or held may also be a value, input by the user on the terminal device 200, indicating the state of using or holding the ingredient.

The detection unit 313 detects a process error with respect to the user who is cooking according to the recipe information. This processing is performed based on, for example, the values of the steps finished/unfinished, the values of the necessary ingredients, and the values of the ingredients used or held, in the above-described recipe execution history DB 332.

Specifically, the detection unit 313 sequentially refers to the values in the column indicating the steps finished/unfinished to identify a relationship such that the value of an earlier step is “unfinished” while the value of a later step is “finished.” The detection unit 313 can thus determine, as a process error, a wrong order of performing steps.

Another type of process error is an ingredient shortage for the recipe. The detection unit 313 refers to the recipe execution history DB 332 to compare the values in the column indicating the necessary ingredients for each step in each recipe being used with the values in the column indicating the ingredients used or held for each step. The detection unit 313 determines whether any step does not meet a condition that each ingredient used or held is the same as the corresponding necessary ingredient and is equal to or greater than the corresponding necessary ingredient in amount. For any step that does not meet the condition, an ingredient shortage can be determined.

If a process error is detected by the detection unit 313, the recipe modification unit 314 checks the erroneous step involved in the process error against the sequence of steps indicated by the recipe. The recipe modification unit 314 subjects the recipe to a recovery measure that includes at least one of reordering steps relevant to the erroneous step, adding a step, or removing a step. The recipe modification unit 314 outputs the modified recipe to the appliance 100 and/or the terminal device 200.

For example, the recipe execution history DB 332 in FIG. 8 indicates that earlier “step 2” is unfinished while later “step 3” has been finished. A process error in the recipe “A” being used is thus identified. The recipe modification unit 314 subjects the recipe information to a recovery measure, for example inserting “step 2” before “step 4” that follows “step 3.” It is to be understood that such a recovery measure for the recipe information is actually implemented by reordering the nodes corresponding to the relevant steps and reconnecting edges in the MRR.

It may be found that taking the above recovery measure may not lead to the completion of the dish to be made according to the recipe. This is the case such as when the process error (including the use of a wrong ingredient) is above a certain extent or when the erroneous process has proceeded to almost a final stage. The recipe modification unit 314 then identifies, from a predetermined recipe list, a recipe that can utilize the cooking up to the erroneous step, that is, a recipe that involves the same or substantially similar steps or ingredients. The recipe modification unit 314 outputs the recipe identified to the appliance 100 and/or the terminal device 200.

For example, the process error may indicate that the amount of an ingredient used or held is less than 80% of the necessary amount of the ingredient. It is then determined that “the certain extent is exceeded” and taking a recovery measure will not lead to the completion of the dish to be made according to the recipe. As another example, the process may proceed to “step 9,” which is immediately before final step “step 10” (e.g., indicating “put on a plate”), while “step 2” remains unfinished. If the cooking operation of “step 2” were performed at this point in time, the resultant product of “step 2” would be obtained too late for incorporation into the final dish. It is therefore determined that the dish according to the recipe information cannot be completed.

The above processing of “identifying from the recipe list” may be performed as follows. Keywords, such as steps or ingredients in the cooking up to the erroneous step, may be used to search the recipe content of the “recipe information files” in the recipe information DB 331. A recipe may then be identified that uses the same or substantially similar steps or ingredients (e.g., a recipe that meets a condition that the amounts of the remaining ingredients are more than 80% of the amounts of the necessary ingredients).

The user who is experiencing the process error may do or may be doing cooking according to other recipe information, in addition to the recipe information involving the process error. That is, the user may be cooking according to multiple pieces of recipe information. The recipe modification unit 314 also appropriately addresses such a situation.

To this end, the recipe modification unit 314 extracts records having the same recipe user name from the recipe execution history DB 332. If the records include the values of multiple recipes used and if the execution dates and times of these recipes are within a predetermined time period, the recipe modification unit 314 determines that the user is cooking with multiple pieces of recipe information.

Based on the attributes of the steps of these pieces of recipe information, the recipe modification unit 314 extracts, from across the pieces of recipe information, steps having attributes designated by the recipe integration rule DB 333. The recipe modification unit 314 outputs the extracted steps to the appliance 100 and/or the terminal device 200 according to the above recipe integration rule DB 333.

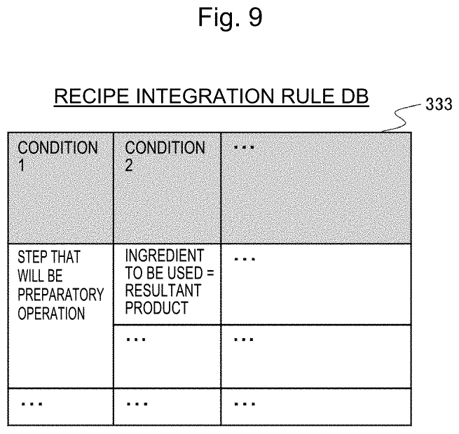

FIG. 9 illustrates an example of the recipe integration rule DB 333. The recipe integration rule DB 333 stores conditions for steps in a mutual user-used relationship across pieces of recipe information, and designates condition values for attributes of steps to be extracted, such as primary conditions 1, secondary conditions 2, and so on.

As an exemplary specific situation, the user who is cooking with recipe information A and recipe information B may experience a process error for the recipe information A as described above. One step in the recipe information A is a potential preparatory operation (e.g., preparation of an ingredient to be used) for a certain step in the recipe information B. The process error in the recipe information A may therefore affect the cooking with the recipe information B.

The recipe modification unit 314 extracts, from the recipe information A and B, attributes of the steps performed correctly before the occurrence of the process error in the recipe information A, and attributes of the steps unfinished in the recipe information B. The recipe modification unit 314 identifies cooking details in a mutual user-used relationship between the two pieces of recipe information. Specifically, the recipe modification unit 314 extracts, as attributes, the necessary ingredients and the resultant product (including the concepts of the completed dish and the intermediate product) in each step.

This user-used relationship may be the relationship between one step and its potential preparatory step, as described above, or the relationship in which a resultant product or a remaining ingredient in one step will be a necessary ingredient in another step.

The recipe modification unit 314 orders the steps of the pieces of recipe information extracted as above in an order consistent with the above user-used relationship identified across the pieces of recipe information, and outputs the sequence of steps to the appliance 100 and/or the terminal device 200. Specifically, the order consistent with the user-used relationship is such an order that one step is performed to obtain a resultant product, and subsequently another step is performed using the resultant product as a necessary ingredient.

(Functional Block Configuration of Appliance 100)

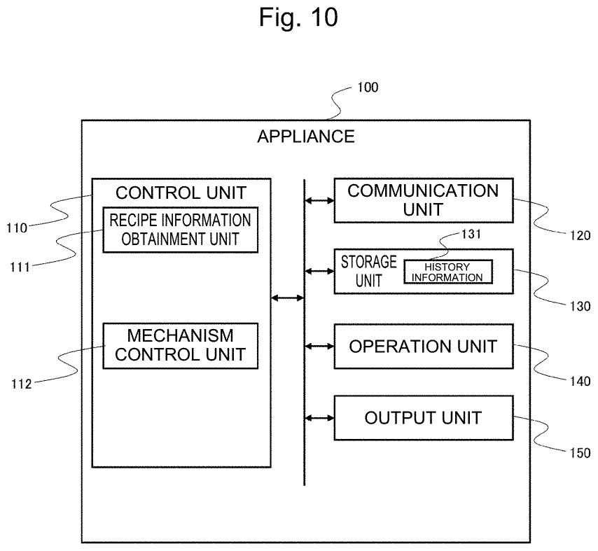

Now, the functional block configuration of the appliance 100 will be described. FIG. 10 is a diagram illustrating the functional block configuration of the appliance 100 according to the present disclosure.

As shown in FIG. 10, the appliance 100 is implemented by the processing circuitry discussed above with respect to FIG. 3. For example, the control unit 110 includes a control unit 110, a communication unit 120, a storage unit 130, an operation unit 140, and an output unit 150.

The control unit 110 includes the CPU 21 and controls the operations of the appliance 100. The communication unit 120 includes the communication module 25 and performs communication over the network NW. The communication unit 120 may have a function of directly communicating with the terminal device 200. The storage unit 130 includes the RAM 22, the ROM 23, and the auxiliary storage device 24, and stores various sorts of information and data. The operation unit 140 includes the input device 26 and receives user operations. The operation unit 140 has physical buttons or software buttons for receiving actions (processing). The output unit 150 outputs recipe information received by the communication unit 120 from the recipe control server 300.

Among the above components, the control unit 110 includes a recipe information obtainment unit 111 and a mechanism control unit 112. The recipe information obtainment unit 111 sends, for example in response to the user's instruction received by the operation unit 140, a recipe information search request to the recipe control server 300 and obtains, through the communication unit 120, an MRR (recipe information) returned by the recipe control server 300. The recipe information obtainment unit 111 also transmits history information 131 maintained in the storage unit 130 to the execution history collection unit 312 in response to a request from the recipe control server 300 or upon reaching a predetermined time. The history information 131 has a configuration similar to the history information 231 described with respect to the terminal device 200.

Once the recipe information obtainment unit 111 obtains the MRR, the mechanism control unit 112 controls the miscellaneous mechanisms 28 (mechanisms in the appliance 100 for performing actions, such as a heating mechanism, a refrigerating and freezing mechanism, a cutting mechanism, and a mixing mechanism) according to the MRR, i.e., the recipe information.

(First Exemplary Operations)

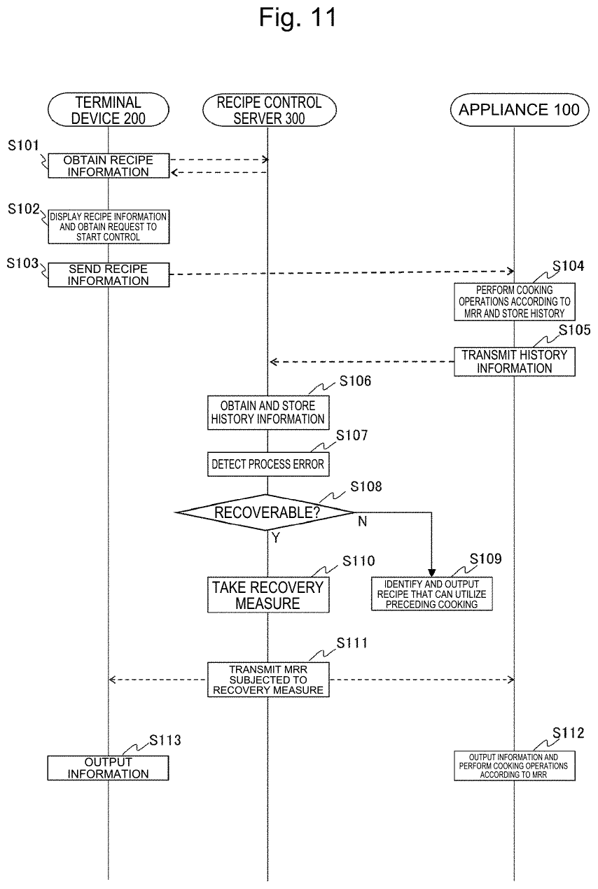

An example of operations of the recipe control system 1 in the present disclosure will be described. FIG. 11 is a diagram illustrating exemplary operations of the recipe control system 1.

As shown in FIG. 11, at step S101, the terminal device 200 responds to the user's operation on the operation unit 240 to obtain recipe information from the recipe control server 300 through the communication unit 220.

At step S102, the terminal device 200 displays the obtained recipe information on the output unit 250 and receives, through the operation unit 240, a request to start controlling the appliance 100 according to the recipe information.

At step S103, in response to the above request to start control, the terminal device 200 transmits, through the communication unit 220, the recipe information to the appliance 100 directly or via the recipe control server 300. The data transmitted includes the recipe ID of the recipe information selected, and further includes the device ID of the appliance 100 to be controlled.

At step S104, the appliance 100 automatically performs cooking operations by controlling the miscellaneous mechanisms 28 according to the recipe information, and changes settings according to user operations. These user operations are related to changes from cooking operations specified in the recipe information being used. The changes may include changing the cooking temperature or cooking time of the appliance 100 and changing the amount of an ingredient, as well as skipping steps, omitting some operations, and changing the order of steps. The appliance 100 stores, in the storage unit 130, the history information 131 (reflecting the above setting changes) of cooking operations performed according to the recipe information.

At step S105, the appliance 100 transmits the above history information 131 to the recipe control server 300. Instead of or in addition to transmitting the history information 131, the history information 231 may be transmitted by the terminal device 200. For example, this history information 231 may include setting change information obtained when the user changes settings of the appliance 100 through the terminal device 200, or may include the user's answers to questions about setting changes asked by the terminal device 200 on a predetermined question screen.

At step S106, the recipe control server 300 receives the history information 131 from the appliance 100 and stores it in the recipe execution history DB 332.

At step S107, the recipe control server 300 detects the user's process error based on the history information 131 stored in the recipe execution history DB 332 and the corresponding recipe information. Detecting a process error refers to detecting a difference between the cooking process performed by the user and the cooking process in the recipe. If a difference between the cooking processes or a difference indicating an ingredient shortage is detected, this means that a predetermined condition is met. That is, the recipe is modified if the predetermined condition is met.

At step S108, for the process error detected, the recipe control server 300 checks the erroneous step involved in the process error against the sequence of steps indicated by the recipe information to determine whether taking any recovery measure will lead to the completion of the dish to be made according to the recipe information.

If the above determination shows that taking any recovery measure will not lead to the completion of the dish to be made according to the recipe information (S108: N), at step S109, the recipe control server 300 identifies, from a predetermined recipe list, a recipe that can utilize the cooking up to the erroneous step. The recipe control server 300 outputs the recipe identified to the terminal device 200 and/or the appliance 100.

If the above determination shows that taking any recovery measure will lead to the completion of the dish to be made according to the recipe information (S108: Y), at step S110, the recipe control server 300 takes a recovery measure that includes at least one of reordering steps relevant to the erroneous step, adding a step, or removing a step.

At step S111, the recipe control server 300 transmits the recipe information subjected to the above recovery measure to the appliance 100 and/or the terminal device 200.

At step S112, the appliance 100 receives the MRR, which is the recipe information transmitted by the recipe control server 300, and performs cooking operations by controlling the miscellaneous mechanisms 28 according to the MRR.

At step S113, the terminal device 200 receives the recipe information transmitted by the recipe control server 300 and displays it on the output unit 250.

As described above, the recipe control system 1 subjects the recipe information to a recovery measure for recovering the recipe user's process error. The modified recipe information is transmitted to the appliance 100 such as an oven, a microwave oven, or a refrigerator, and/or to the terminal device 200 such as a mobile terminal like a smartphone. Thus, the recipe information is provided to the user, and appropriate automatic cooking is performed in the appliance 100.

(Second Exemplary Operations)

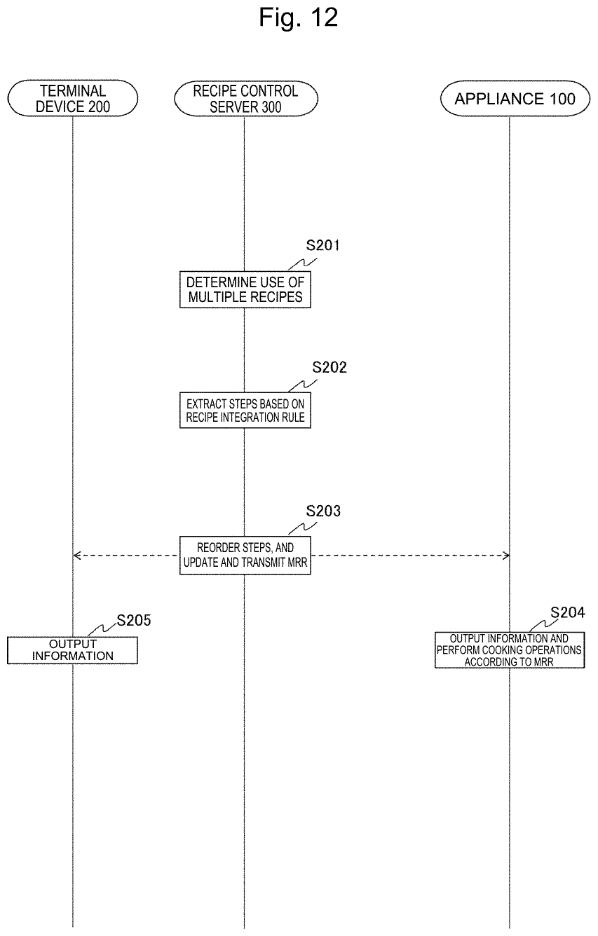

Another example of operations of the recipe control system 1 in the present disclosure will be described. FIG. 12 is a diagram illustrating second exemplary operations of the recipe control system 1. The operations here show the process of appropriately addressing a situation in which the user who is experiencing a process error does or is doing cooking according to other recipe information in addition to the recipe information involving the process error, that is, the user is cooking according to multiple pieces of recipe information.

As shown in FIG. 12, at step S201, the recipe control server 300 extracts records having the same recipe user name from the recipe execution history DB 332. If the records include the values of multiple recipes used and if the execution dates and times of these recipes are within a predetermined time period, the recipe control server 300 determines that the user is cooking with multiple pieces of recipe information.

At step S202, based on the attributes of the steps of these pieces of recipe information, the recipe control server 300 extracts, from across the pieces of recipe information, steps having attributes designated by the recipe integration rule DB 333.

For example, the recipe control server 300 extracts, from recipe information A and B, attributes of the steps performed correctly before the occurrence of the process error in the recipe information A, and attributes of the steps unfinished in the recipe information B. The recipe control server 300 identifies cooking details in a mutual user-used relationship between the two pieces of recipe information. Specifically, the recipe control server 300 extracts, as attributes, the necessary ingredients and the resultant product (including the concepts of the completed dish and the intermediate product) in each step and identifies, based on the attributes extracted, steps in a user-used relationship.

At step S203, the recipe control server 300 orders the steps of the pieces of recipe information extracted as above in an order consistent with the above user-used relationship identified across the pieces of recipe information, and outputs the sequence of steps to the appliance 100 and/or the terminal device 200.

At step S204, the appliance 100 receives the MRR, which is the recipe information that includes the sequence of steps ordered as above, from the recipe control server 300. The appliance 100 performs cooking operations by controlling the miscellaneous mechanisms 28 according to the MRR received.

At step S205, the terminal device 200 receives the recipe information that includes the sequence of steps ordered as above from the recipe control server 300, and outputs the recipe information.

<Other Configurations>

Various alternative embodiments, implementations, and operational techniques will become apparent to those skilled in the art from the present disclosure.

FIG. 1 illustrates the appliance 100 and the terminal device 200 that are separate from each other. However, the appliance 100 and the terminal device 200 may be operated by integrating the functions and information in one of the appliance 100 and the terminal device 200 into the other. The functions and information in the recipe control server 300 may also be implemented in the appliance 100 or the terminal device 200.

A program causing a computer to perform processes of the recipe control system 1 may be provided. The program may be recorded on a computer-readable medium, which may be used to install the program into the computer. The computer-readable medium having the program recorded thereon may be a non-transitory recording medium, which may be, but not limited to, a recording medium such as a CD-ROM or a DVD-ROM, for example.

The recipe control system according to the present disclosure addresses situations in which a user changes a setting of a cooking appliance such as the heating temperature or the heating time, for the user's convenience or due to the conditions of ingredients, resulting in recipe modification. The recipe control system also addresses cases in which an incorrectly performed step or the use or preparation of a wrong ingredient is found in an advanced stage of cooking while totally unexpected by the user, resulting in unintended recipe modification. To this end, the recipe control system takes a recovery measure, such as reordering, adding, or removing steps. The recipe control system also proposes a recipe that can utilize preceding cooking or remaining ingredients, or presents a cooking process that reflects a user-used relationship of steps across multiple recipes.

Thus, the recipe control system according to the present disclosure enables flexibly and appropriately addressing various cooking errors and proposing a recipe suitable for the situation.

The present disclosure can be implemented in various other forms and allows various eliminations, substitutions, and modifications to be made without departing from the spirit of the invention. The present disclosure and its variations are within the scope and spirit of the invention, as well as within the scope of the features set forth in the claims and their equivalents.

Aspects of the present disclosure can also be realized by a computer of a system or apparatus (or devices such as a CPU, a micro processing unit (MPU), or the like) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., a non-transitory computer-readable medium).

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

Reference Signs List

1: recipe control system
21: CPU
22: RAM
23: ROM
24: auxiliary storage device
25: communication module
26: input device
27: output device
28: mechanisms
100: appliance
110: control unit
111: recipe information obtainment unit
112: mechanism control unit
120: communication unit
130: storage unit
131: history information
140: operation unit
150: output unit
200: terminal device
210: control unit
211: recipe information obtainment unit
220: communication unit
230: storage unit
231: history information
240: operation unit
250: output unit
300: recipe control server
310: control unit
311: recipe information management unit
312: execution history collection unit
313: detection unit
314: recipe modification unit
320: communication unit
330: storage unit
331: recipe information DB
332: recipe execution history DB
333: recipe integration rule DB

1. A server device comprising: a memory and at least one processor configured to:
detect a second cooking process performed by a user who is cooking according to a cooking recipe involving a first cooking process; and
in a case where a predetermined condition that the second cooking process detected by the detection unit deviates from the first cooking process is met, performs control for outputting a modified cooking recipe resulting from subjecting the first cooking process to at least one of reordering relevant steps, adding a step, or removing a step based on a configuration of the first cooking process and a configuration of the second cooking process that meets the predetermined condition.

2. The server device according to claim 1,
wherein in a case where the predetermined condition is met and a dish achievable with the modified cooking recipe is different from a dish to be made with the cooking recipe involving the first cooking process,
the memory and at least one processor configured to perform control for outputting an alternative recipe that allows cooking based on the second cooking process and that is different from the cooking recipe involving the first cooking process.

3. The server device according to claim 1,
wherein the detection unit is further capable of detecting an ingredient held by the user,
the predetermined condition is met if the ingredient detected by the detection unit is insufficient for the ingredient required for the cooking recipe involving the first cooking process, and
the memory and at least one processor configured to perform control for outputting an alternative recipe that allows cooking with a resultant product of cooking performed according to the second cooking process meeting the predetermined condition and with ingredients for the cooking recipe involving the first cooking process, and that is different from the cooking recipe involving the first cooking process.

4. The server device according to claim 1,
wherein the memory and at least one processor configured to perform control for extracting steps having an attribute designated by a predetermined recipe integration rule from across the plurality of recipes based on attributes of steps of each of the plurality of recipes, and outputting, according to the recipe integration rule, the steps extracted, if the cooking uses a plurality of recipes.

5. The server device according to claim 1,
wherein, if the predetermined condition is met and if a dish achievable with the modified cooking recipe is the same as a dish to be made with the cooking recipe involving the first cooking process, the memory and at least one processor configured to perform control for outputting the modified cooking recipe.

6. The server device according to claim 1,
wherein, if the predetermined condition is met, the memory and at least one processor configured to perform control for identifying a modified cooking recipe from a list of recipes similar to the cooking recipe involving the first cooking process.

7. The server device according to claim 1,
wherein the memory and at least one processor configured to perform control for outputting the modified cooking recipe to a cooking appliance, or to an electronic device outputting the cooking recipe involving the first cooking process.

8. The server device according to claim 1, wherein
the memory and at least one processor configured to perform control to collect cooking information from an appliance device used by the user, and
to detect the second cooking process performed by the user by processing the cooking information.

9. A method for controlling a server device , the method comprising: performing control to detect a second cooking process performed by a user who is cooking according to a cooking recipe involving a first cooking process; and
performing control to, in a case where a predetermined condition that the second cooking process detected deviates from the first cooking process is met, performs control for outputting a modified cooking recipe resulting from subjecting the first cooking process to at least one of reordering relevant steps, adding a step, or removing a step based on a configuration of the first cooking process and a configuration of the second cooking process that meets the predetermined condition.

10. A non-transitory computer-readable recording medium storing computer executable instructions which, when executed by a computer, cause the computer:
to display a first group of items on a display screen, detect a second cooking process performed by a user who is cooking according to a cooking recipe involving a first cooking process; and
in a case where a predetermined condition that the second cooking process detected deviates from the first cooking process is met, to performs control for outputting a modified cooking recipe resulting from subjecting the first cooking process to at least one of reordering relevant steps, adding a step, or removing a step based on a configuration of the first cooking process and a configuration of the second cooking process that meets the predetermined condition.
